(19) United States
(12) Patent Application Publication
(10) Pub. No.: US 2010/0039343 A1
(43) Pub. Date: Feb. 18, 2010

(54) ANTENNA DEVICE

(75) Inventors: Hiroyuki Uno, Sendai-shi (JP); Yutaka Saito, Sendai-shi (JP); Yoshio Koyanagi, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/447,077

(22) PCT Filed: Oct. 26, 2006
(86) PCT No.: PCT/JP2006/321429

§ 371 Date: Apr. 24, 2009

(51) Int. Cl. H01Q 19/10; H01Q 9/16; H01Q 1/38

(52) U.S. Cl. 343/818; 343/834; 343/700 MS

(57) ABSTRACT

Provided is an antenna device which is small and low in height to be easily mounted on a small radio and forms a main beam, which has excellent radiation pattern frequency characteristics and is tilted in the horizontal direction. Slot elements (103a, 103b) of an antenna (101) are excited with a phase difference (d). A reflection plate (105) is provided with a plurality of patch elements (107) having a resonance frequency higher than the center frequency of the antenna (101), and a plurality of patch elements (108) having a resonance frequency lower than the center frequency of the antenna (101) around the patch elements (107).

### TECHNICAL FIELD

The present invention relates to an antenna apparatus. For example, the present invention is suitable for use as a stationary radio apparatus and radio terminal apparatus in high-speed radio communication systems.

### BACKGROUND ART

In high-speed radio communication systems such as wireless LAN systems, it is necessary to take measures against multipath fading and shadowing to realize high-speed transmission. A sector antenna is studied as one of the measures. A sector antenna aligns a plurality of antenna elements where the main beams are directed in different directions, and selectively switches a plurality of antenna elements depending on radio propagation environments.

Generally, antennas installed in stationary radio apparatuses mounted in ceilings and radio terminal apparatuses for notebook computers used on desks are requested to have a flat structure and a small size from the viewpoint of productivity and portability. Further, from the viewpoint of indoor communication environment, the directivity of these antennas preferably tilts the angles of elevations of main beams horizontally from the vertical direction with respect to the antenna face.

Up to now, as this kind of antennas, a sector antenna using a loop antenna is proposed as disclosed in Patent Document 1. This sector antenna is configured by aligning a plurality of loop antennas having conductors in a folded shape on a plane at a given distance from a plate reflector. A loop antenna is formed by connecting conductors in a folded shape and by placing a plate reflector, so that it is possible to form main beams tilted in a horizontal direction and, furthermore, it is possible to switch the main beam direction by switching feeding positions. In this way, one loop antenna realizes beams in two directions, so that features of the sector antenna include the footprint smaller.

Further, as another antenna, a sector antenna using slot elements is proposed as disclosed in Patent Document 2. This sector antenna is configured by placing four slot elements at a given distance from a plate reflector, so that features of the sector antenna include a simple configuration and a very small footprint. By arranging the four slot elements in a square shape and by feeding two opposing slot elements with a phase difference, main beams tilted in a horizontal direction are formed. Further, by switching the phase differences, the main beams can be switched to the opposite direction, so that it is possible to form main beams in four directions by four slot elements arranged in a square shape.

By the way, there is a problem with the sector antennas disclosed in Patent Documents 1 and 2 that the distance to the plate reflector needs at least ¼ wavelength or greater although the footprint can be made very small. For example, in the case of a 5 GHz operating frequency, the distance to the plate reflector needs at least 25 mm or greater. Considering the sector antenna is mounted in a radio apparatus, this thickness prevents miniaturization, and the distance to the plate reflector is preferably as narrow as possible.

As a technique for making a low-profile antenna that makes a radiation direction a single direction using a plate reflector, EBG (Electromagnetic BandGap) structure adopting a plate reflector is proposed up to now.

As this kind of antennas, a dipole antenna placed on an EBG plate reflector is proposed as disclosed in Non-patent Document 1. According to this document, even in a very low-profile antenna configuration of placing a dipole antenna a 0.04 wavelength apart from an EGB plate reflector on which a plurality of patch elements are arranged, it is possible to realize impedance matching and obtain good unidirectional radiation characteristics.

Further, as another antenna, a spiral antenna placed on an EBG plate reflector is proposed as disclosed in Non-patent Document 2. According to this document, by placing a spiral antenna a 0.06 wavelength apart from an EGB plate reflector on which a plurality of patch elements are arranged, it is possible to make low-profile without damaging circular polarized wave characteristics.

Further, as another antenna, a two-frequency antenna placed on an EBG plate reflector is proposed as disclosed in Non-patent Document 3. In this two-frequency antenna, two orthogonal dipole antennas are placed at a very narrow interval on an EBG plate reflector on which a plurality of rectangle patch elements are arranged. By this means, the dipole antennas placed in parallel on the short side of the patch element operate as antennas for a high frequency band, and the dipole antennas placed in parallel on the long side of the patch element operate as antennas for a low frequency band. As a result, it is possible to suppress the deterioration of efficiency of radiation caused by a closely placed plate reflector and realize a wideband two-frequency antenna.

Further, as another antenna, a phased dipole array antenna placed on an EBG plate reflector is proposed as disclosed in Non-patent Document 3. According to this document, by placing a phase dipole array antenna a 0.14 wavelength a part from the surface of an EGB plate reflector on which a plurality of patch elements are arranged, it is possible to realize a low-profile antenna having main beams tilted in a horizontal direction.
Patent Document 1: Japanese Patent Application Laid-Open No. 2005-72915
Patent Document 2: Japanese Patent Application Laid-Open No. 2005-269199
Patent Document 3: Japanese Patent Application Laid-Open No. 2005-94360
Non-patent Document 1: IEEE Trans. Antennas Propagat., vol. 51, no. 10, pp. 2691-2703, October 2003.
Non-patent Document 2: Proc. Antennas and Propagation Soc. Int. Symp., vol. 1, pp. 831-834, June 2004.
Non-patent Document 3: IEICE general conference, 2006, B-1-63

### DISCLOSURE OF INVENTION

### Problems to be Solved by the Invention

Although the dipole antenna disclosed in Non-patent Document 1, the spiral antenna disclosed in Non-patent Document 2, the two-frequency antenna disclosed in Non-patent Document 3 and the phased dipole array antenna disclosed in Non-patent Document 3 are realized by using an EBG plate reflector on which a plurality of patch elements are aligned, no consideration is given to the frequency characteristics of radiation patterns. The frequency characteristic of radiation patterns is one of important characteristics in the case of applying an antenna to radio communication systems, and, as shown in the above documents, when an EBG plate reflector is adopted in an antenna, by resonation characteristics of patch elements, the radiation patterns are more likely to show frequency characteristics.

It is therefore an object of the present invention to provide an antenna apparatus that is small and low-profile so as to be installed easily in a small radio apparatus, that has radiation patterns of good frequency characteristics and that can form main beams with a tilt in a horizontal direction.

### Means for Solving the Problem

According to an aspect of the antenna apparatus of the present invention, an antenna apparatus adopts a configuration including: a plate reflector that includes: a first plate conductor formed of a metallic material; a plurality of first conductor elements provided at a given distance from the first plate conductor; a plurality of second conductor elements aligned around the plurality of first conductor elements; and a connection conductor that connects electrically each center of the plurality of first conductor elements and each center of the plurality of second conductor elements with the first plate conductor; and a first and second radiation sources that are provided on a side of the plurality of first conductor elements and the plurality of second conductor elements at a given interval from the plate reflector and that are excited with a phase difference between the first and second radiation sources.

Further, according to an aspect of the antenna apparatus of the present invention, the antenna apparatus adopts a configuration including: the plate reflector has an electromagnetic bandgap structure, in which the plurality of first and second conductor elements have resonance characteristics in a first and second frequency bands, respectively; and the first frequency band is set higher than the second frequency band.

According to these configurations, it is possible to realize a small and low-profile antenna apparatus that has radiation patterns of good frequency characteristics and that can form a main beam tilted in a horizontal direction.

Further, according to an aspect of the antenna apparatus of the present invention, in the above configuration, the first radiation source and the second radiation source include a first slot element and a second slot element formed in parallel on the second plate conductor, and, further, the antenna apparatus adopts a configuration including: a third slot element that is formed in the second plate conductor such that the third slot element is orthogonal to the first slot element; and a fourth slot element that is formed in the second plate conductor at the given interval from the third slot element in parallel, wherein the third and the fourth slot elements are excited with the phase difference between the third element and the fourth element.

Further, according to an aspect of the antenna apparatus of the present invention, the first radiation source and second radiation source include a first dipole element and a second dipole element placed in parallel, and, further, the antenna apparatus adopts a configuration including: a third dipole element that is placed such that the third dipole element is orthogonal to the first dipole element; and a fourth dipole element that is placed at the given distance from the third dipole element in parallel, wherein the third and the fourth dipole elements are excited with the phase difference between the third dipole antenna and the fourth dipole antenna.

According to these configurations, it is possible to realize a multi-sector antenna apparatus in four directions that is small and low-profile, and that has radiation patterns of good frequency characteristics.

### Advantageous Effect of the Invention

According to the present invention, it is possible to realize an antenna apparatus that is small and low-profile, and forms main beams with a tilt in a horizontal direction and that has radiation patterns of good frequency characteristics.

### BRIEF DESCRIPTION OF DRAWINGS

FIG. 1A is a perspective view showing the configuration of the antenna apparatus according to Embodiment 1 of the present invention;

FIG. 1B is a side view showing the configuration of the antenna apparatus according to Embodiment 1;

FIG. 2 is a plane view showing the antenna configuration;

FIG. 3 is a plane view showing the configuration of the plate reflector;

FIG. 4 shows characteristics of the plate reflector of the antenna apparatus according to Embodiment 1;

FIG. 5 shows the directivity of the antenna apparatus according to Embodiment 1;

FIG. 6A is a perspective view showing the configuration of the antenna apparatus as a comparison example against Embodiment 1;

FIG. 6B is a side view showing the configuration of the antenna apparatus as a comparison example against Embodiment 1;

FIG. 7 shows the directivity of the antenna apparatus of FIGS. 6A and 6B;

FIG. 8A is a perspective view showing the configuration of the antenna apparatus as a comparison example against Embodiment 1;

FIG. 8B is a side view showing the configuration of the antenna apparatus as a comparison example against Embodiment 1;

FIG. 9 shows the directivity of the antenna apparatus of FIGS. 8A and 8B;

FIG. 10A shows radiation characteristics between the antenna apparatus of Embodiment 1 and the antenna apparatus of a comparison example;

FIG. 10B shows radiation characteristics between the antenna apparatus of Embodiment 1 and the antenna apparatus of a comparison example;

FIG. 11A is a perspective view showing the configuration of the antenna apparatus according to Embodiment 2;

FIG. 11B is a cross-sectional view showing the configuration of the antenna apparatus according to Embodiment 2;

FIG. 12 is a plane view showing the configuration of the plate reflector;

FIG. 13 shows the directivity of the antenna apparatus according to Embodiment 2;

FIG. 14A shows radiation characteristics between the antenna apparatus of Embodiment 2 and the antenna apparatus of a comparison example;

FIG. 14B shows radiation characteristics between the antenna apparatus of Embodiment 2 and the antenna apparatus of a comparison example;

FIG. 15A is a perspective view showing the configuration of the antenna apparatus according to Embodiment 3;

FIG. 15B is a side view showing the configuration of the antenna apparatus according to Embodiment 3; and

FIG. 16 shows the directivity of the antenna apparatus according to Embodiment 3.

### BEST MODE FOR CARRYING OUT THE INVENTION

Now, embodiments of the present invention will be described in detail with reference to the accompanying drawings. Further, the same numerals are assigned to components having the same configurations or functions in the figures and the description thereof will not be repeated.

### Embodiment 1

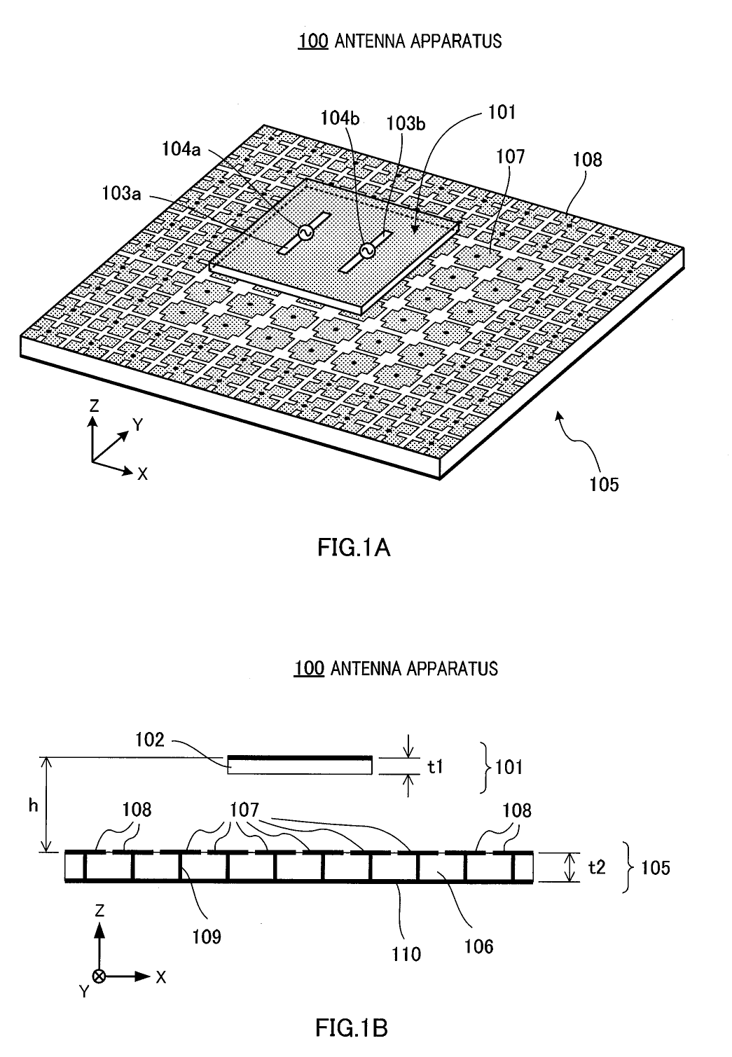

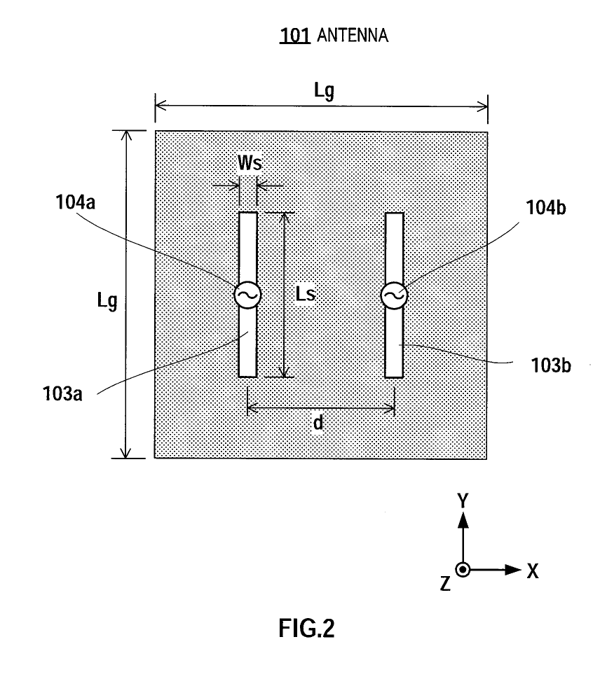

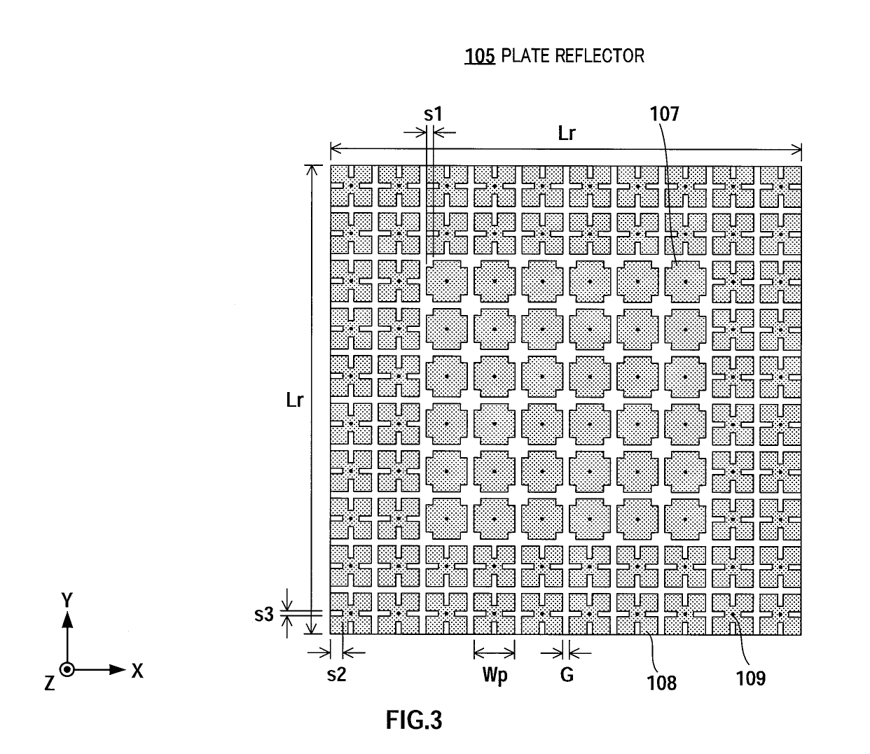

The antenna apparatus according to Embodiment 1 of the present invention will be described using FIGS. 1 to 10. FIG. 1A is a perspective view showing the configuration of the antenna apparatus according to Embodiment 1 of the present invention. FIG. 1B is a side view showing the configuration of the antenna apparatus, that is, a view seen from the −Y side in FIG. 1A. FIG. 2 is a plane view of antenna 101 of FIGS. 1A and 1B, seen from the +Z side in FIG. 1B. FIG. 3 is a plane view of plate reflector 105 shown in FIGS. 1A and 1B, seen from the +Z side in FIG. 1A.

Antenna apparatus 100 has antenna 101 and plate reflector 105. Antenna 101 and plate reflector 105 are placed given distance h apart as known from FIG. 1B.

Plate reflector 105 has: ground conductor 110 as a first plate conductor formed of a metallic material; patch elements 107 as a plurality of first conductor elements placed at a given distance from the first plate conductor; patch elements 108 as a plurality of second conductor elements aligned around a plurality of first conductor elements; and through hole 109 as a connection conductor for connecting electrically each center of a plurality of first conductor elements and each center of a plurality of second conductor elements with the first plate conductor.

Further, according to the present embodiment, plate reflector 105 has an EBG (Electromagnetic BandGap) structure where a plurality of patch elements 107 and 108 have resonance characteristics in the first and second frequency bands, respectively. In addition, patch elements 107 and 108 are configured such that the first frequency band is higher than the second frequency band.

Antenna apparatus 100 according to the present embodiment such that a plurality of patch elements 107 and 108 have an EBG structure having resonance characteristics in a first and second frequency bands and, in order to make the first frequency band higher than the second frequency band in this way, several efforts are made to antenna apparatus 100. The configurations will be described later in detail.

Antenna 101 is placed on the side of patch elements 107 and 108 from plate reflector 105 at given distance h. Slot elements 103a and 103b as first and second radiation sources excited with a phase difference between them are provided on antenna 101.

Slot elements 103a and 103b are formed by cutting copper foil on the surface of dielectric substrate 102. Dielectric substrate 102 is a dielectric substrate having a relative permittivity εr of, for example, 2.6 and thickness t1, and its plane shape is a Lg×Lg square.

Slot elements 103a and 103b as first and second radiation sources having a length of Ls and a width of Ws, are aligned parallel at element interval d and excited by feed points 104a and 104b, respectively. At this time, feed points 104a and 104b are excited having phase difference δ (i.e. the phase at feed point 104b—the phase at feed point 104a). Although a case has been explained where slot elements 103a and 103b are directly excited by feed points 104a and 104b, a microstrip line may be formed on the rear face of dielectric substrate 102 and the slot elements may also be excited by electromagnetic field coupling. Antenna 101 configured in this way is placed at given distance h from the surface of plate reflector 105 (i.e. the +Z plane).

In plate reflector 105, a plurality of patch elements 107 and 108 are formed on the surface of dielectric substrate 106, and the center parts of the patch elements 107 and 108 are individually connected with ground conductor 110 formed on the rear face of dielectric substrate 106 via through holes 109. Dielectric substrate 106 is a double-sided, copper-clad, dielectric substrate having a relative permittivity εr of, for example, 2.6 and a thickness of t2, and its plane shape is a Lr×Lr square.

Patch element 107 is a conductor with sides of a length of Wp and placed in the center part of plate reflector 105, that is, immediately below and close to antenna 101. A square notch with sides of a length of s1 is formed in each vertex of the conductor. Patch element 108 is a conductor with sides of a length of Wp and placed so as to surround the perimeter of patch elements 107. A slit of s2×s3 is each formed in the center of the sides of the conductor. N×N patch elements 107 and 108 are arranged at element interval G between the elements. By configuring plate reflector 105 in this way, it is possible to regard the plate reflector as an equivalent to a parallel LC resonant circuit.

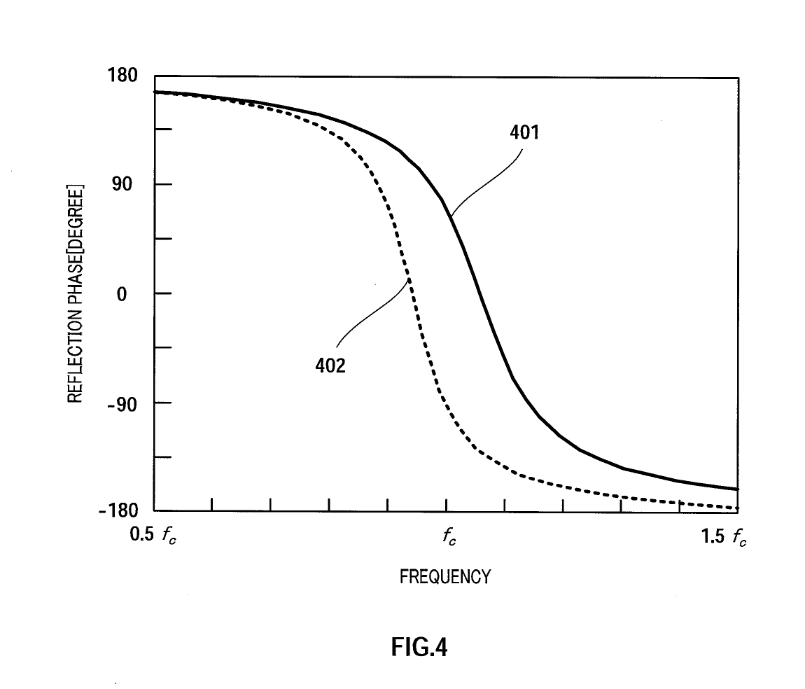

FIG. 4 shows the reflection phases of patch elements 107 and 108 in a case where patch elements 107 and 108 are periodically arranged in two dimensions and where a plane wave enters patch elements 107 and 108 from the front direction. Reflection phase characteristics 401 and 402 show the reflection phase characteristics of patch elements 107 and 108, respectively. The reflection phase in FIG. 4 is assumed a case where thickness t2 of dielectric substrate 106 is a 0.027 wavelength, the length Wp of a side of a patch element is a 0.23 wavelength, element interval G is a 0.017 wavelength, s1 is a 0.025 wavelength, s2 is a 0.058 wavelength, and s3 is a 0.017 wavelength. The reflection phase is zero degree upon resonance, and the surface of the plate reflector is in the same condition as a perfect magnetic conductor. In FIG. 4, it is evident from reflection phase characteristic 401 that patch element 107 resonates with a higher frequency than center frequency fc of antenna 101, and it is evident from reflection phase characteristic 402 that patch element 108 resonates with a lower frequency than center frequency fc of antenna 101. If patch elements 107 and 108 each have a square shape with sides of a length of a 0.23 wavelength without notches or slits, resonate with center frequency fc of antenna 101.

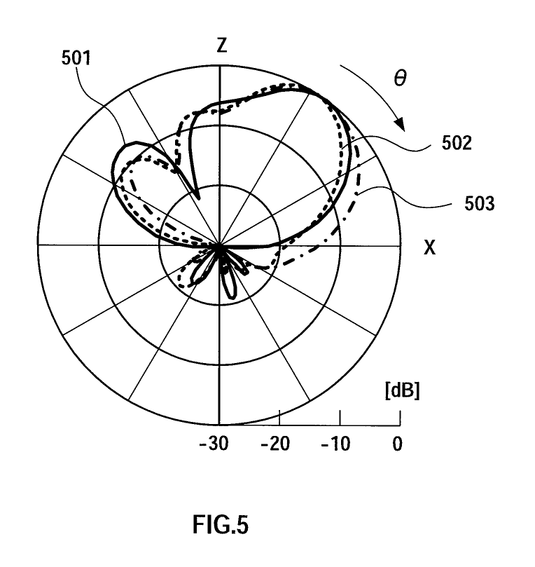

FIG. 5 shows the directivity on the vertical (XZ) plane where distance h is a 0.125 wavelength. The directivity of FIG. 5 is shown in a case where antenna 101 and plate reflector 105 are configured as follows. As for antenna 101, thickness t1 and dimension Lg of antenna 101 are a 0.027 wavelength and a 0.77 wavelength, respectively, length Ls of slot elements 103a and 103b are a 0.27 wavelength, width Ws is a 0.017 wavelength, element interval d is a 0.33 wavelength and phase difference δ is 70 degrees. As for plate reflector 105, 6×6 patch elements 107 are arranged in the center, that is, near antenna 101, and patch elements 108 are aligned every two elements around patch elements 107 (i.e. N=10) and total dimension Lr of plate reflector 105 is 2.48 wavelengths. The dimensions of patch element 107 and patch element 108 are the same values as described above.

In FIG. 5, directivity 501 to 503 shows the directivity of vertical Eθ polarized wave component when the operating frequencies are a 0.98 fc, a 1.02 fc and a 1.06 fc, respectively, and it is evident that the main beams tilted in the direction of 35 degree elevation angle θ are obtained in any frequencies. Further, it is possible to check small changes in the radiation patterns with respect to the frequencies.

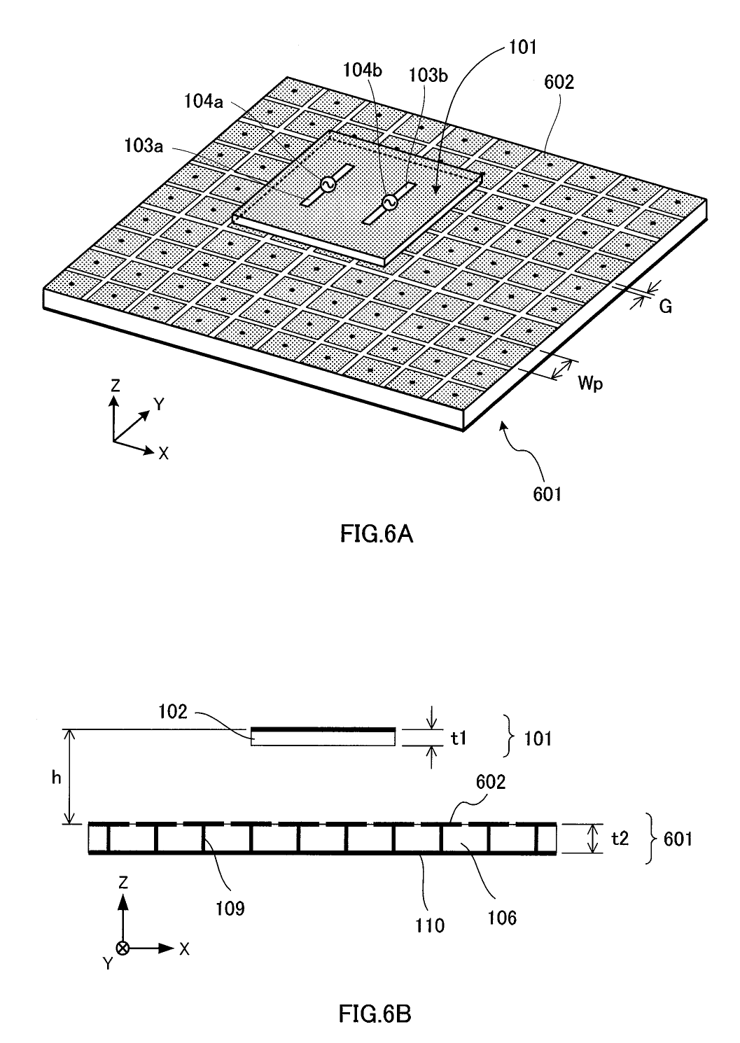

Now, as comparison example 1 with respect to the present embodiment, a case where the resonance frequency of all patch elements is fc, that is, a case where the patch element is a square shape with sides of a length of a 0.23 wavelength, will be described. FIG. 6A is a perspective view showing the configuration of the antenna apparatus where all patch elements 602 formed on plate reflector 601 are square shapes. FIG. 6B is a side view of the antenna apparatus seen from the −Y direction in FIG. 6A. Plate reflector 601 is configured by arranging 10×10 patch elements 602 each having a square shape with sides of a length of a 0.23 wavelength at element interval G of a 0.017 wavelength. That is, this plate reflector is the same configuration as the plate reflector where patch elements 107 and 108 in the present embodiment are formed without notches and slits.

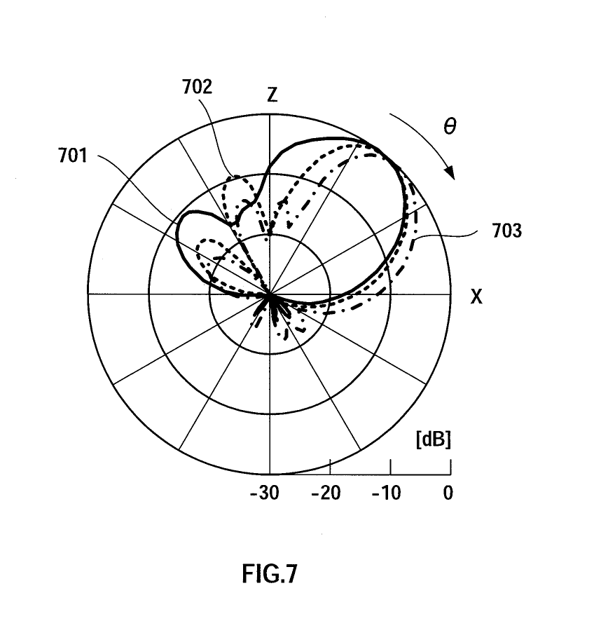

FIG. 7 shows the directivity on the vertical (XZ) plane where distance h is a 0.125 wavelength in the configuration shown in FIGS. 6A and 6B. Directivity 701 to 703 shows the directivity of vertical Eθ polarized wave component when the operating frequencies are a 0.98 fc, a 1.02 fc and a 1.06 fc, respectively. By the frequency characteristic of reflection phase in plate reflector 601, it is evident that the radiation patterns with respect to the frequencies change significantly.

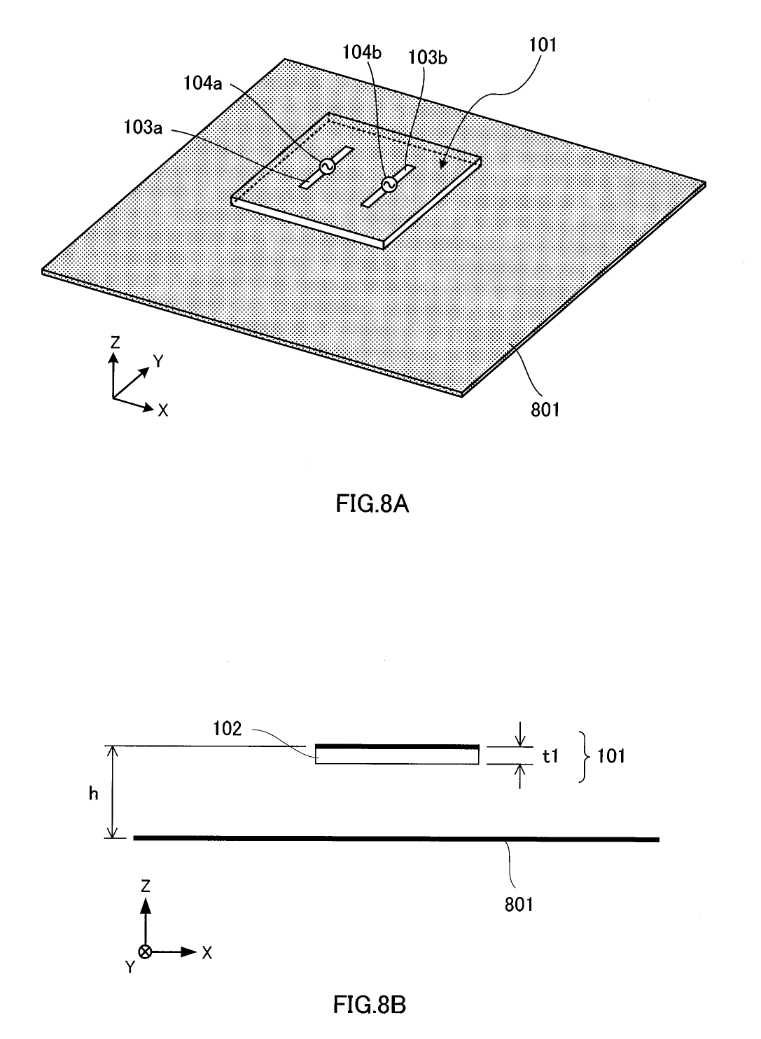

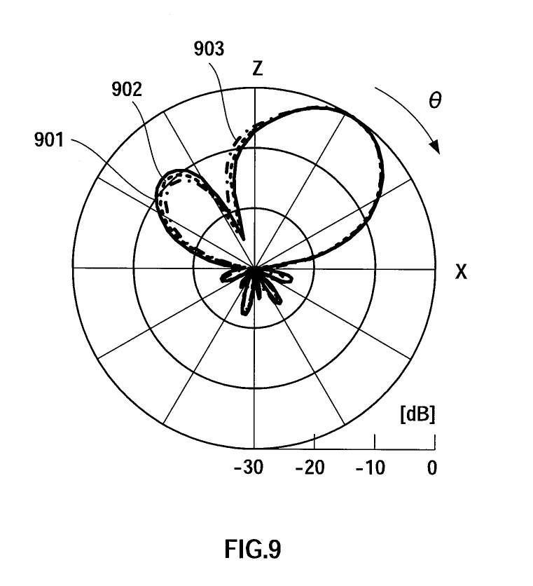

Now, as comparison example 2 with respect to the present embodiment, a case where the plate reflector is a metallic conductor will be described. FIG. 8A is a side view showing the configuration of the antenna apparatus where the plate reflector is a metallic conductor and FIG. 8B is a side view of the antenna apparatus seen from the −Y direction in FIG. 8A. FIG. 9 shows the directivity on the vertical (XZ) plane where distance h is a 0.33 wavelength in the configuration shown in FIGS. 8A and 8B. Directivity 901 to 903 shows the directivity of vertical Eθ polarized wave component when the operating frequencies are a 0.98 fc, a 1.02 fc and a 1.06 fc, respectively. Similar to the configuration of the present embodiment shown in FIGS. 1A and 1B, it is evident that the main beams tilted in the direction of 35 degree elevation angle θ are obtained in any frequencies. Further, plate reflector 801 does not have frequency characteristics, so that changes are little in the radiation patterns with respect to the frequencies.

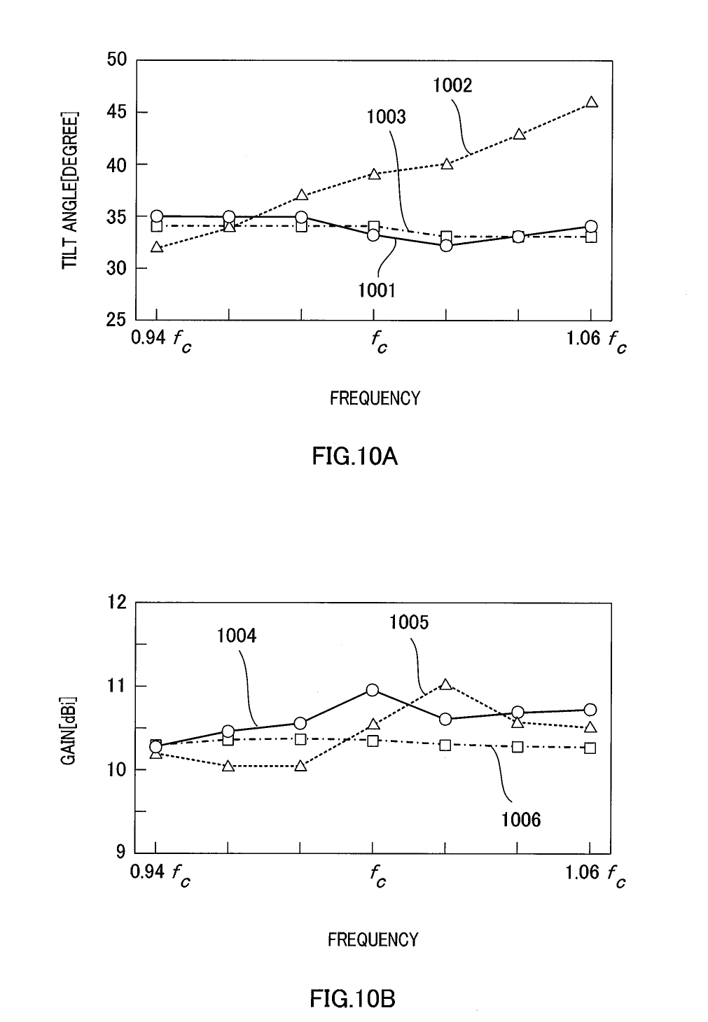

FIGS. 10A and 10B show frequency characteristics of the tilt angles and gains between antenna apparatus 100 of the present embodiment (FIGS. 1A and 1B), the antenna apparatus of comparison example 1 (FIGS. 6A and 6B) and the antenna apparatus of comparison example 2 (FIGS. 8A and 8B). In FIGS. 10A and 10B, characteristics 1001 and 1004 show the frequency characteristics of the tilt angle and the gain where distance h in FIG. 1B is a 0.125 wavelength in antenna apparatus 100 of the present embodiment, characteristics 1002 and 1005 show the frequency characteristics of the tilt angle and the gain where distance h in FIG. 6B (comparison example 1) is a 0.125 wavelength, and characteristics 1003 and 1006 show the frequency characteristics of the tilt angle and the gain where distance h in FIG. 8B (comparison example 2) is a 0.33 wavelength. It is evident from FIG. 10A that, in characteristic 1001 of antenna apparatus 100 of the present embodiment, a change in the tilt angle is less than in characteristic 1002 of comparison example 1, and almost the same tilt angle is obtained as characteristic 1003 of comparison example 2 although the distance to the plate reflector is narrower than in comparison example 2. Further, as for the gain shown in FIG. 10B, changes are little in the frequencies in all of the configurations.

In this way, according to the present embodiment, in a tilt beam antenna configured with two slot elements and a plate reflector, a plurality of patch elements 107 having a higher resonant frequency than the center frequency of antenna 101 and a plurality of patch elements 108, which are arranged around patch elements 107, and which have a lower resonant frequency than the center frequency of antenna 101, are provided on plate reflector 105, so that it is possible to realize low-profile tilted beam antenna apparatus 100 that has radiation patterns of good frequency characteristic.

Although a case has been explained with the present embodiment about the configuration of the antenna that feeds with a phase difference two slot elements 103a and 103b at a given interval, the same effect may be obtained as a linear element configuration such as a dipole antenna. Further, the same effect may be applied by using an antenna having two current peaks with various phase differences in one element. That is, an antenna may need to be configured by providing the first and second radiation sources on the side of a plurality of first and second conductor elements of the plate reflector at a given interval, and by exciting the radiation sources with a phase difference each other.

Further, although a case has been explained with the present embodiment where the patch element is a square shape, the same effect may be applied to a circular shape or a regular polygon.

### Embodiment 2

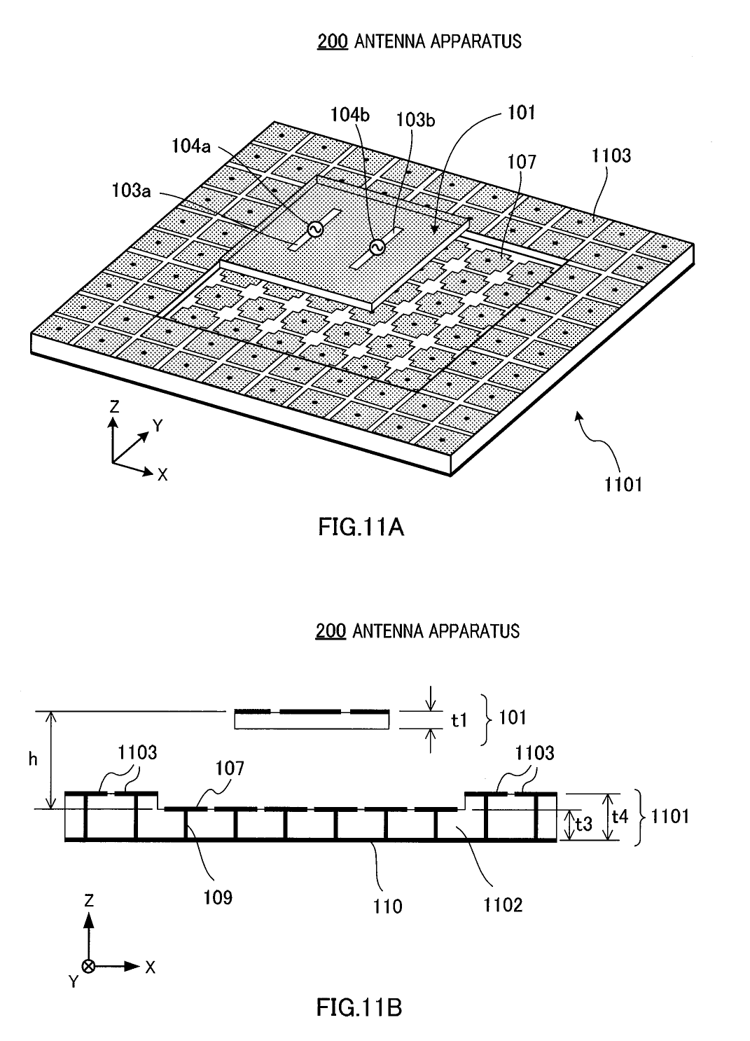

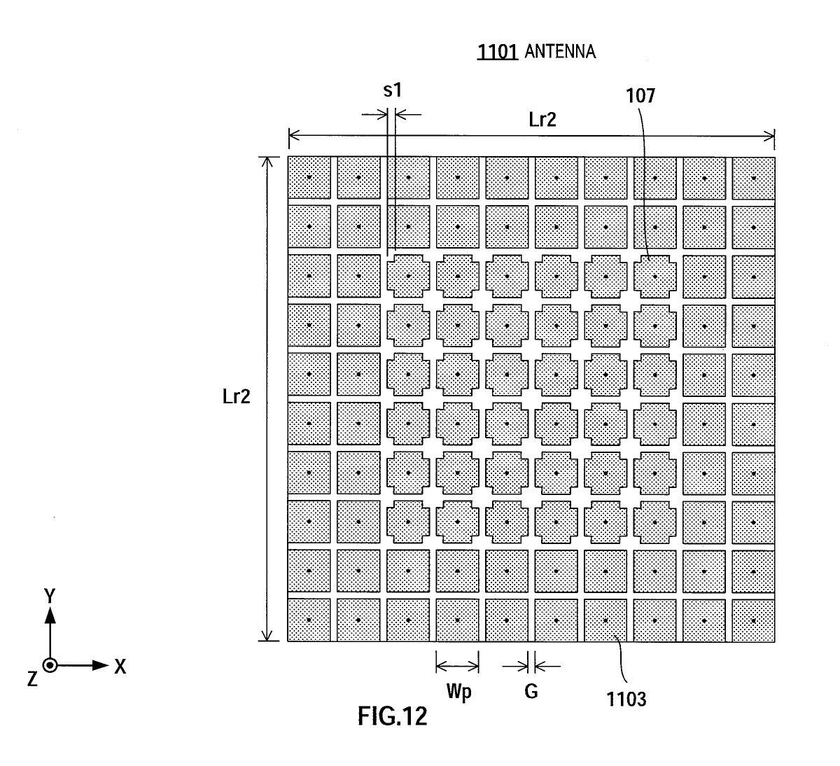

The antenna apparatus according to Embodiment 2 of the present invention will be explained using FIGS. 11 to 14. FIG. 11A is a perspective view showing the configuration of the antenna apparatus according to Embodiment 2 of the present invention. FIG. 11B is a cross-sectional view showing the configuration of the antenna apparatus, that is, a view of near the center of antenna apparatus 200 along the X axis in FIG. 11A, seen from the −Y side. FIG. 12 is a plane view of plate reflector 1101 shown in FIGS. 11A and 11B, seen from the +Z side in FIG. 11A.

Referring to these figures, in plate reflector 1101, a plurality of patch elements 107 and 1103 are formed on the surface of dielectric substrate 1102, and the center parts of the patch elements 107 and 1103 are individually connected with ground conductor 110 formed on the rear face of dielectric substrate 1102 via through holes 109.

Dielectric substrate 102 is a dielectric substrate having a concave shape having a relative permittivity εr of, for example, 2.6, thickness t3 of the part where patch elements 107 arranged immediately below or near antenna 101 are formed, and thickness t4 (greater than t3) of the part where patch elements 1102 are formed.

Patch element 1103 is a square conductor with sides of a length of Wp and which is formed around patch elements 107. The reflection phase where patch elements 1103 are periodically arranged in two dimensions and a plane wave enters the patch elements from the front direction, is at zero degree, that is, the patch elements resonate at higher frequency than a case where patch elements 107 are periodically arranged and than center frequency fc of antenna 101.

These N×N patch elements 107 and 1103 are arranged at element interval G between the patch elements, and sides of a length of entire plate reflector 1101 are Lr2×Lr2. Antenna 101 is placed above plate reflector 1101 configured in this way at distance h from the face forming patch element 107.

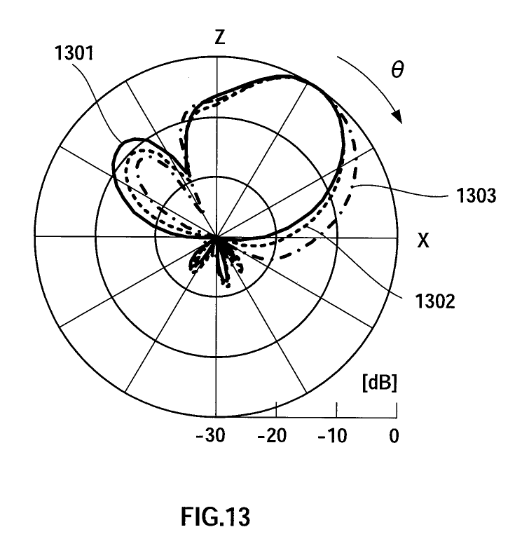

FIG. 13 shows the directivity on the vertical (XZ) plane where distance h is a 0.125 wavelength. The directivity of FIG. 13 is a case where thicknesses t3 and t4 of dielectric substrate 1102 are 0.027 and 0.042 wavelengths, the dimension Lr2 is 2.48 wavelengths, 6×6 patch elements 107 are arranged, patch elements 1103 are aligned every two elements around patch elements 107 (i.e. N=10).

In FIG. 13, directivity 1301 to 1303 show the directivity of vertical Eθ polarized wave component when the operating frequencies are a 0.98 fc, a 1.02 fc and a 1.06 fc, respectively, and it is evident that the main beams tilted in the direction of 35 degree elevation angle θ are obtained in any frequencies. Further, it is possible to check small changes in the radiation patterns with respect to the frequencies.

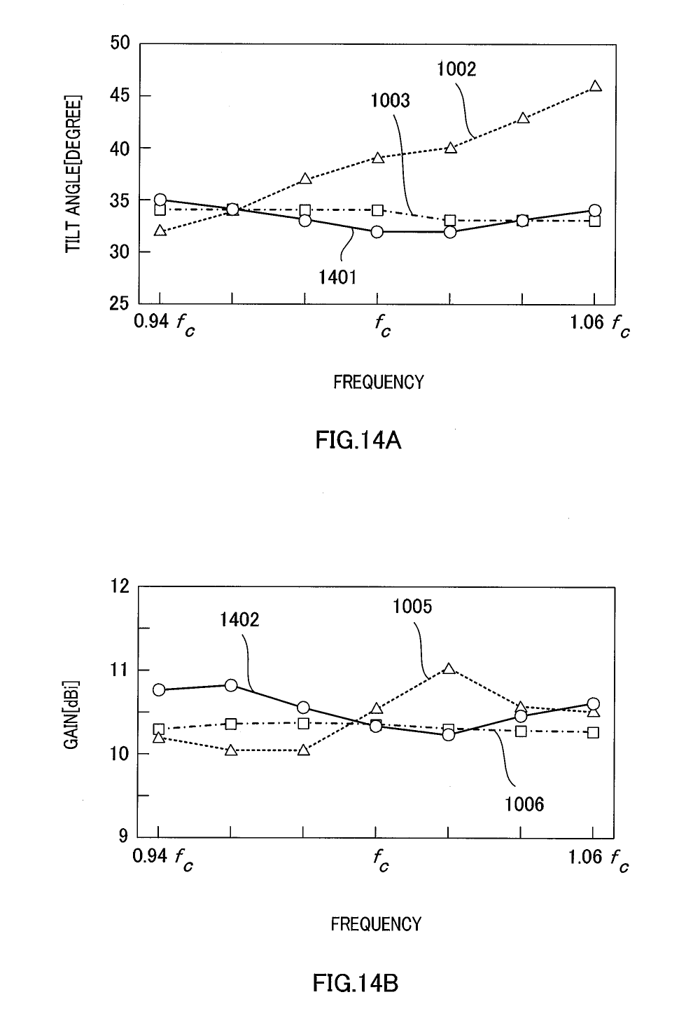

FIGS. 14A and 14B show frequency characteristics of the tilt angles and gains between antenna apparatus 200 of the present embodiment (FIGS. 11A and 11B), the antenna apparatus of comparison example 1 (FIGS. 6A and 6B) and the antenna apparatus of comparison example 2 (FIGS. 8A and 8B). In FIGS. 14A and 14B, characteristics 1401 and 1402 show the frequency characteristics of the tilt angle and the gain where distance h in FIG. 11B is a 0.125 wavelength in antenna apparatus 200 of the present embodiment. It is evident from FIG. 14A that, in characteristic 1401 of antenna apparatus 200 of the present embodiment, a change in the tilt angle is less than in characteristic 1002 of comparison example 1, and almost the same tilt angle is obtained as characteristic 1003 of comparison example 2 although the distance to the plate reflector is narrower than in comparison example 2. Further, as for the gain shown in FIG. 14B, changes are little in frequencies in any configurations.

In this way, according to the present embodiment, in the tilt beam antenna configured with two slot elements and a plate reflector, plate reflector 1101 is configured such that a plurality of patch elements 107 and 1103 are arranged on concave-shaped dielectric substrate 1102, so that, as in Embodiment 1, it is possible to realize low-profile tilted beam antenna apparatus 200 that has radiation patterns of good frequency characteristics.

Although a case has been explained with the present embodiment where notches are provided with patch element 107 arranged in the center part of plate reflector 1101, it is possible to increase the resonant frequency difference between patch element 107 in the center part of plate reflector 1101 and patch element 1103 around plate reflector 1101 by increasing the difference between the thickness of the center of dielectric substrate 1102 and the thickness of the surrounding even if notches are not provided, so that it is possible to obtain the same effect as the present embodiment.

Further, although a case has been explained with the present embodiment where plate reflector 1101 is configured by concave-shaped dielectric substrate 1102, even when a dielectric substrate has the same thickness (i.e. flat plate) and when the relative permittivity varies between the center of the dielectric substrate and around the dielectric substrate, so that it is possible to obtain the same effect as the present embodiment.

### Embodiment 3

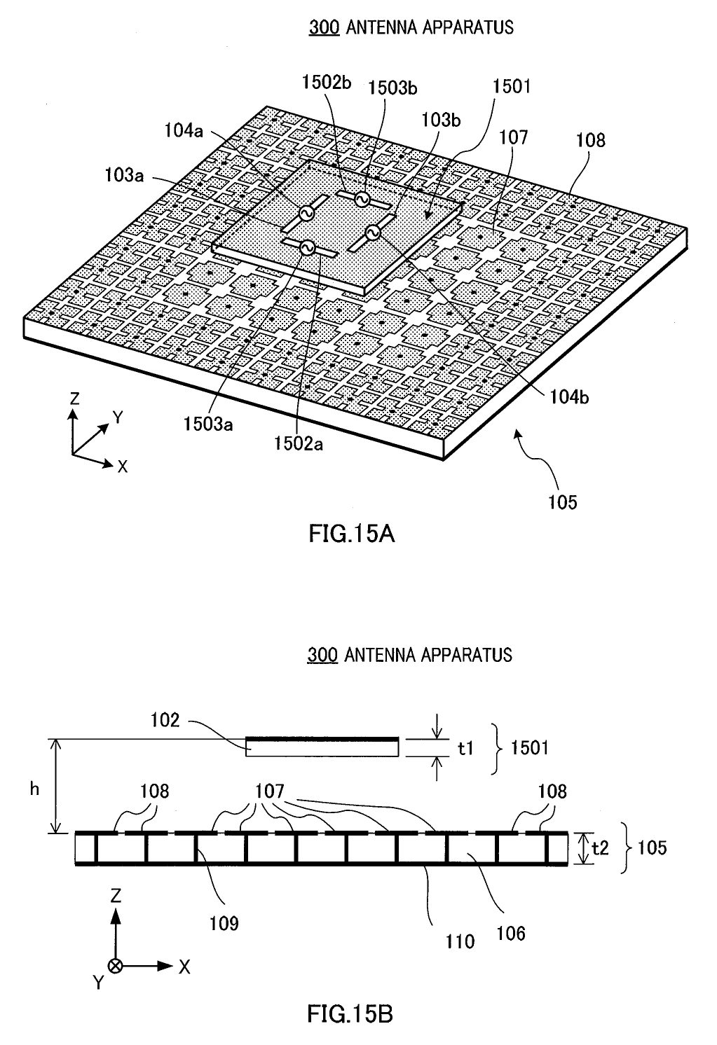

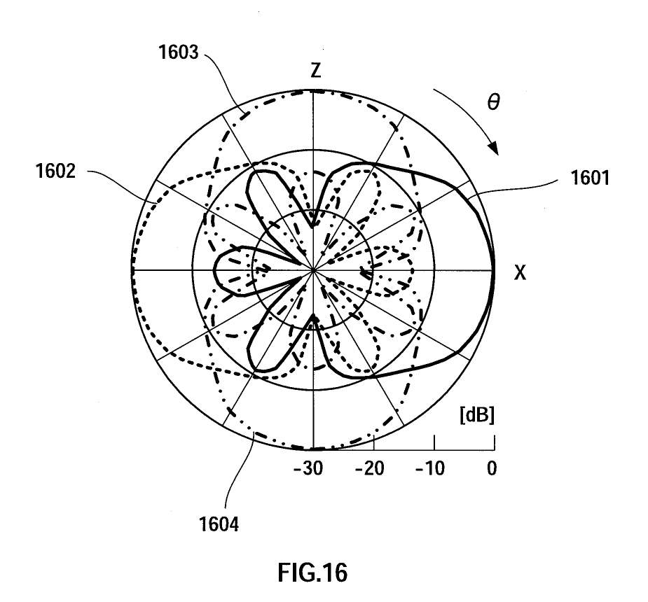

The antenna apparatus according to Embodiment 3 of the present invention will be explained using FIGS. 15 and 16. FIG. 15A is a perspective view showing the configuration of the antenna apparatus according to Embodiment 3 of the present invention. FIG. 15B is a side view showing the configuration of the antenna apparatus, that is, a view seen from the −Y side in FIG. 15A.

Antenna apparatus 300 of the present embodiment is different from antenna apparatus 100 of Embodiment 1 in the configuration of antenna 1501. Antenna 1501 has slot elements 103a, 103b, 1502a and 1502b formed from cutting copper foil on the surface of dielectric substrate 102. Slot elements 1502a and 1502b face each other such that slot elements 1502a and 1502b are orthogonal to slot elements 103a and 103b. That is, slot elements 103a, 103b, 1502a and 1502b are aligned in a square shape.

Slot elements 103a and 103b are fed with a phase difference (phase difference δ1=the phase at feed point 104b—the phase at feed point 104a) by feed points 104a and 104b, respectively. At this time, feed points 1503a and 1503b are short-circuited. Similarly, slot elements 1502a and 1502b are fed with a phase difference (phase difference δ2=the phase at feed point 1503b—the phase at feed point 1503a) by feed points 1503a and 1503b, respectively, and at this time, feed points 104a and 104b are short-circuited.

FIG. 16 shows the directivity of antenna apparatus 300, where distance h shown in FIG. 15B is a 0.125 wavelength, and the directivity of a conical plane at the elevation angle of 35 degrees. Directivity 1601 shows the directivity of vertical Eθ polarized wave component when slot elements 103a and 103b are excited at 70 degree phase difference δ1, and it is possible to check that the main beam is directed to the +X direction. Similarly, directivity 1602 shows the directivity of vertical Eθ polarized wave component when slot elements 103a and 103b are excited at −70 degree phase difference δ1. Directivity 1603 shows the directivity of vertical Eθ polarized wave component when slot elements 1502a and 1502b are excited at 70 degree phase difference δ2, and directivity 1604 shows the directivity of vertical Eθ polarized wave component when slot elements 1502a and 1502b are excited at −70 degree phase difference δ2. Accordingly, it is possible to check that the main beams are directed to the −X direction, the +Y direction and the −Y direction, respectively. In this way, by switching exciting slot elements and by switching excitation phases, it is possible to form beams in four directions.

In this way, according to the present embodiment, in a tilted beam antenna configured by four slot elements and a plate reflector, a plurality of patch elements 107 having a higher resonant frequency than the center frequency of antenna 101 and a plurality of patch elements 108, which are arranged around patch elements 107, and which have a lower resonant frequency than the center frequency, are provided on plate reflector 105, and four slot elements 103a, 103b, 1502a and 1502b are aligned in a square shape and facing slot elements are excited with a phase difference. By this means, it is possible to realize low-profile, small-footprint and four-direction multi-sector antenna apparatus 300.

### INDUSTRIAL APPLICABILITY

The antenna apparatus according to the present invention provides an advantage of forming a main beam tilted in a horizontal direction, and realizing a small and low-profiled antenna having radiation patterns of good frequency characteristics and having a simple configuration suitable for implementing in miniaturized radio apparatus, and is applicable to a stationary radio apparatus and a radio terminal apparatus in high speed radio communication systems.

1. An antenna apparatus comprising:
a plate reflector that comprises:
a first plate conductor formed of a metallic material;
a plurality of first conductor elements provided at a given distance from the first plate conductor;
a plurality of second conductor elements aligned around the plurality of first conductor elements; and
a connection conductor that connects electrically each center of the plurality of first conductor elements and each center of the plurality of second conductor elements with the first plate conductor; and
a first and second radiation sources that are provided on a side of the plurality of first conductor elements and the plurality of second conductor elements at a given interval from the plate reflector and that are excited with a phase difference between the first and second radiation sources.

2. The antenna apparatus according to claim 1, wherein:
the plate reflector has an electromagnetic bandgap structure, in which the plurality of first and second conductor elements have resonance characteristics in a first and second frequency bands, respectively; and
the first frequency band is set higher than the second frequency band.

3. The antenna apparatus according to claim 2, wherein:
the plurality of first conductor elements and the plurality of second conductor elements are patch elements in square shapes; and
the first frequency band is set higher than the second frequency band by providing a notch in at least one vertex in said each first element.

4. The antenna apparatus according to claim 2, wherein:
the plurality of first conductor elements and the plurality of second conductor elements are patch elements in square shapes; and
the first frequency band is set higher than the second frequency band by providing a slit in at least one side of said each first element.

5. The antenna apparatus according to claim 2, wherein, the first frequency band is set higher than the second frequency band by making a distance between the plurality of first conductor elements and the first plate conductor narrower than a distance between the plurality of second conductor elements and the second plate conductor.

6. The antenna apparatus according to claim 1, wherein the first radiation source and the second radiation source comprise a first slot element and a second slot element formed in parallel on the second plate conductor.

7. The antenna apparatus according to claim 1, wherein the first radiation source and second radiation source comprise a first dipole element and a second dipole element placed in parallel.

8. The antenna apparatus according to claim 6, further comprising:
a third slot element that is formed in the second plate conductor such that the third slot element is orthogonal to the first slot element; and
a fourth slot element that is formed in the second plate conductor at the given interval from the third slot element in parallel,
wherein the third and the fourth slot elements are excited with the phase difference between the third element and the fourth element.

9. The antenna apparatus according to claim 7, further comprising:
a third dipole element that is placed such that the third dipole element is orthogonal to the first dipole element; and
a fourth dipole element that is placed at the given distance from the third dipole element in parallel,
wherein the third and the fourth dipole elements are excited with the phase difference between the third dipole antenna and the fourth dipole antenna.
